(19) United States
(12) Patent Application Publication
(10) Pub. No.: US 2011/0017843 A1
(43) Pub. Date: Jan. 27, 2011

(54) SYSTEM FOR ACTUATING AND CONTROLLING THE MOBILE COWLING OF A TURBOJET ENGINE NACELLE

(75) Inventors: Vincent Pierre Germain Le Coq, La Riviere Saint Sauveur (FR); Marc Gerome, Le Havre (FR)

Correspondence Address: CANTOR COLBURN LLP, 20 Church Street, 22nd Floor, Hartford, CT, 06103, US

(73) Assignee: AIRCELLE, GONFREVILLE L'ORCHER (FR)

(21) Appl. No.: 12/922,576

(22) PCT Filed: Feb. 4, 2009
(86) PCT No.: PCT/FR09/00125

§ 371 Date: Sep. 14, 2010

(30) Foreign Application Priority Data
Mar. 14, 2008 (FR) 0/801396

(51) Int. Cl. F02K 1/00

(52) U.S. Cl. 239/265.33

(57) ABSTRACT

The invention relates to a system for actuating and controlling at least one mobile cowling (1) of a turbojet engine nacelle that comprises at least one electric-control locking means (4) of said cowling, at least one actuator (2) for driving said cowling, characterised in that the system further comprises a central electronic control unit (15) capable of driving the locking means and the actuator according to a predetermined actuation sequence. The invention also relates to a nacelle including a maintenance mobile cowling provided with such an actuation system.

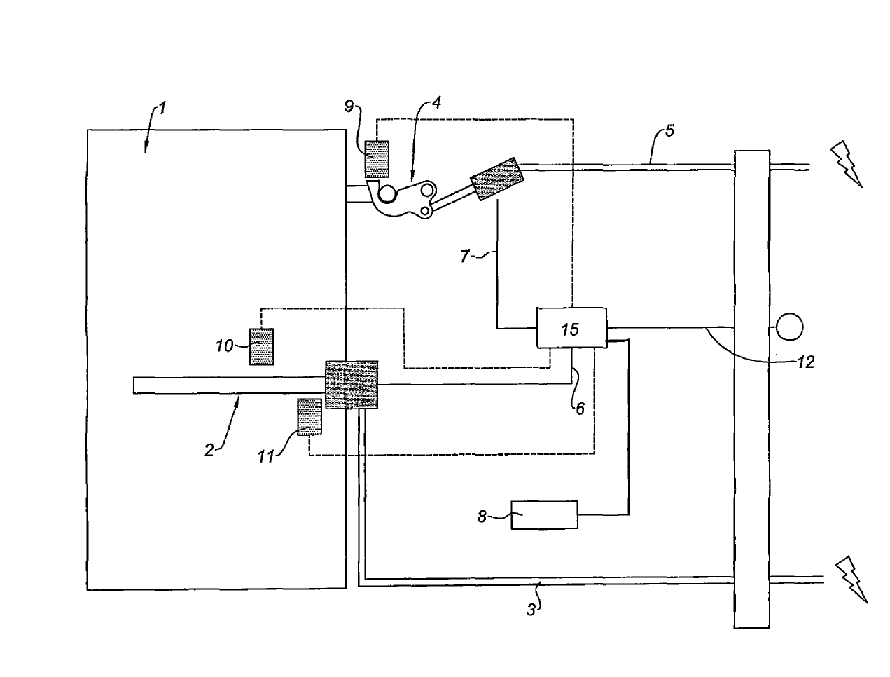

### TECHNICAL FIELD

This invention relates to a system for actuating and controlling of at least one mobile cowling of a turbojet engine nacelle, comprising at least one electric-control locking means of said cowling and at least one actuator for driving said cowling.

### BACKGROUND

An airplane is powered by several turbojet engines each housed in a nacelle which also shelters an assembly of supplementary actuating devices associated with the operation thereof and providing various functions when the turbojet engine is running or stopped. These supplementary actuating devices comprise in particular a mechanical system for actuating thrust inverters, but also one or more mobile cowlings designed to enable access to the interior of the nacelle in view of maintenance operations.

More specifically, a nacelle generally has a structure comprising an air inlet upstream of the engine, a central section for surrounding a turbojet engine fan, and a downstream section for surrounding the combustion chamber of the turbojet engine and sheltering thrust inverter means.

The air inlet comprises, on the one hand, an inlet lip adapted to allow optimal uptake towards the turbojet engine of air required to power the fan and the internal compressors of the turbojet engine, and on the other hand, a downstream structure onto which is mounted the lip and for channelling conveniently the air towards the fan blades, said downstream structure comprising an outer ferrule and an inner acoustic panel. The assembly is attached upstream of a fan casing belonging to the central section of the nacelle. The outer ferrule may comprise one or more mobile panels providing an access to the interior of the air inlet structure in view of maintenance operations. An example for a maintenance panel is described in application FR 06/08599 in the name of the applicant.

The central structure surrounds the fan and it is generally broken down into an inner wall forming said fan casing and an outer wall in the shape of removable cowlings mounted pivoting about a longitudinal axis forming a hinge on the upper part (at 12 o'clock) of the nacelle in view of providing an access to the interior of the nacelle.

Thus, such maintenance cowlings, fitted to the various areas of a nacelle, can be mounted mobile, generally in translation or in rotation, and in this latter case opening, for instance like a butterfly.

Actuating of the maintenance cowlings is achieved by means of one or more pneumatic, hydraulic or electric actuators.

Moreover, each cowl is associated with manual locking means ensuring the retention thereof in the closed position.

The operations as a whole of unlocking and opening, and reciprocally closing and locking, is time consuming to a maintenance operator and require several manoeuvres. Moreover, the manual closing of the locking means can be a source of errors, omissions, or poor closing, thereby being a danger in flight.

### BRIEF SUMMARY

The invention provides a simple and reliable system for actuating by ensuring opening of one or more mobile cowlings and providing a simplification of the locking and unlocking manoeuvres for the maintenance cowlings and with a greater safety.

To this end, this invention relates to a system for actuating and controlling of at least one mobile cowling of a turbojet engine nacelle, comprising at least one electric-control locking means of said cowling, at least one actuator for driving said cowling, characterised in that it also comprises a central electronic control unit capable of driving the locking means and the actuator according to a predetermined actuation sequence.

Thus, by associating the maintenance cowling to a central control system, it is possible to implement one or more adapted opening and/or closing sequences to be implemented by the control unit managing then as a whole the locking/unlocking, and activation operations.

The implementation of such an automatic sequence facilitates greatly the work of the operator and results in a significant saving of time, particularly since the latter does not have to move any longer around the nacelle to open or close the various mobile cowlings.

The automation of locking and unlocking of the cowlings allows also the implementation of a prestressing adjustment of the mobile cowling in the closed position.

Advantageously, the system for actuating comprises at least one means for detecting the locked or unlocked status of the locking means, said detection means being capable to return the information to the control system for processing and/or display.

Still more advantageously, the system for actuating comprises at least one position sensor of the mobile cowling, said position sensor being capable of returning the information to the control system for processing and/or display.

Advantageously, the system for actuating comprises at least one approach sensor of a closed position of the mobile cowling, said sensor being capable of returning the information to the control system for processing in view of limiting the effort issued by the electromechanical actuator and/or limiting the speed and/or warning, through sound or light for instance, of closing or opening.

Preferably, the system for actuating comprises at least one manual control member connected to the control system.

Advantageously, the control unit is integrated to an actuator.

Advantageously, the central control unit comprises at least one status information outlet directed for instance to the cockpit. Thus, the pilot can realise visually in particular the good locking of the cowlings.

Preferably, the actuator is an electromechanical actuator.

This invention also relates to a turbojet engine nacelle comprising an air inlet structure capable of directing an air stream towards a turbojet engine fan and a central structure for surrounding said fan and wherein is attached the air Inlet structure in order to ensure aerodynamic continuity, the air inlet structure comprising, on the one hand, at least an internal panel fixed to the central structure and forming with the latter a fixed structure of the nacelle, and on the other hand, at least one external longitudinal panel attached in a removable manner to the fixed structure and integrating an air inlet lip so as to form a removable air inlet structure, characterised in that the removable air inlet structure is associated with a system for actuating according to the invention.

### BRIEF DESCRIPTION OF THE DRAWING

The implementation of the invention will be better understood with the help of the detailed description, which is outlined below with respect to the accompanying drawing wherein the only FIGURE is a schematic representation of a system for actuating according to the invention.

### DETAILED DESCRIPTION

A nacelle (not shown) constitutes a tubular housing for a turbojet engine through which the nacelle channels the air stream generated thereby by defining internal and external aerodynamic lines needed to obtain optimum performances. The nacelle also shelters various components needed to run the turbojet engine as well as complementary systems, such as a thrust inverter.

The nacelle is designed for being attached to a fixed structure of an airplane, such as a wing, through a pylori.

More specifically, a nacelle has a structure comprising a front section forming an air inlet, a central section comprising a casing surrounding a turbojet engine fan, and a rear section surrounding the turbojet engine and capable of sheltering a thrust inverter system.

To allow an access inside the nacelle during ground maintenance operations, the central structure comprises one or more movable panels forming cowlings each one including at least a portion of an outer wall of the central structure. Along the nacelle, there are mobile cowlings, which can open for instance like a butterfly, by articulating the latter about hinges arranged close to the engine strut at the upper portion of the nacelle, but still laterally or by translation.

Each mobile cowling is associated with locking means providing retention thereof in the closed position.

Thus, in the closed position, the movable cowlings provide external aerodynamic continuity of the nacelle while after unlocking and opening the cowlings allow an access to the interior of the nacelle for performing maintenance operations.

The air inlet structure may also have such mobile cowlings.

A system for actuating and controlling according to the invention is shown schematically in the only FIGURE present.

A mobile cowling 1 is capable to be actuated through at least an electromechanical actuator 2 powered from an electrical supply line 3, and is associated to electric-control locking means 4 and powered by an electrical power line 5.

Although the only FIGURE present shows only a single actuator 2 and only a single locking means 4, the number thereof is obviously not limited, and the purpose of the invention is also activating of several cowlings 1, each one capable of being actuated by one or more actuators 2 and associated to one or several locking means 4.

The system for controlling also comprises a central electronic control unit 15 comprising, on the one hand, a first driving outlet 6 capable of transmitting driving orders to the actuator 2, and on the other hand, a second driving outlet 7 capable of transmitting orders to the locking means 4 in order to drive thereto the opening or closing.

Thus, the control unit is therefore capable of driving all the actuators 2 and the locking means 4 according to an order received from a control box casing 8 designed to be operated by an operator.

Moreover, in order to optimise the opening and closing sequences, the control system also comprises an assembly of sensors capable of ascending the status information to the control unit 15.

More specifically, it will be provided a status sensor 9 for each locking means 4, a closing approach sensor 10 of the cowling 2, and a closed position detector 11.

Obviously, this list of sensors is not exhaustive and any type of sensor (position . . . ) might be added, necessary to implement a desired sequence of opening or closing.

The information returned by the sensors 9, 10, 11 is therefore ascended at the control unit 15 for processing and/or display.

The control unit, through release of information 12 towards the cockpit of the airplane can also ascend various status information.

An operator wishing to manoeuvre the maintenance cowlings of a nacelle will proceed as follows.

From an initial position wherein the cowling is closed and locked, the operator controls the opening by actuating on the control box casing 8.

The central control unit 15 receives then this order and implements the appropriate sequence.

The control unit 15 sends, in the first place an unlocking order to the locking means 4.

The sensor 9 then sends unlocking information by the unlocking means 4. When this information is received by the control unit 5, the latter can then order the actuator 2.

Shutdown of the actuator 2 could be made by a simple mechanical stop.

Conversely, from an initial position wherein the cowling is opened, the operator controls the closing by operating on the control box casing 8.

The central control unit 15 then receives this order and implements the appropriate sequence.

The control unit 5 therefore controls, in the first place the return of the actuator 2 in the retracted position.

The sensor 10 indicates the approach to the closed position. The control unit 15 then orders an effort limitation of the actuator at the end of the run to avoid shocks in the locks or other sensitive parts and/or limit the speed and/or warn (either by sound or light means, for instance) of the closure.

Once the cowling 2 is back in the closed position, the sensor 11 confirms the closure thereof to the control unit 15.

The latter can then order the closure of the locking means 4. The sensor 9 confirms the occurred good closing of the locking means 4.

During these manoeuvres, the information thereof as a whole is ascended to the cockpit of the airplane.

Although the invention has been described with a particular example of an embodiment, it is perfectly evident that it is not exhaustive and that it comprises all the technical equivalents of the described means as well as their combinations, should the latter be within the frame of the invention.

1. System for actuating and controlling of at least one mobile cowling of a turbojet engine nacelle that comprises at least one electric-control locking means of said cowling, at least one actuator for driving said cowling, and a central electronic control unit capable of driving the locking means and the actuator according to a predetermined actuation sequence.

2. System for actuating according to claim 1, further comprising at least one detection means of the locked or unlocked status of the locking means said detection means being capable to return information to the control unit for processing and/or display.

3. System for actuating according to claim further comprising at least one position sensor of the mobile cowling, said position sensor being capable of returning information to the control unit for processing and/or display.

4. System for actuating according to claim 1, further comprising at least one approach sensor of a closing position of the mobile cowling, said sensor being capable of returning information to the control unit for processing in view of limiting effort delivered by the electromechanical actuator and/or limiting speed thereof and/or warn of closing and/or of opening.

5. System for actuating according to claim 1, further comprising at least one manually controlled member connected to the control unit.

6. System for actuating according to claim 1, wherein the control unit is integrated to an actuator.

7. System for controlling according to claim 1, wherein the central control unit comprises at least one status information outlet directed to the cockpit.

8. System for controlling according to claim 1, wherein the actuator is an electromechanical actuator.

9. Nacelle for turbojet engine comprising an air inlet structure capable of channelling an air stream towards a turbojet fan and a central structure designed for surrounding said fan, and wherein is attached the air input structure in such a manner so as to ensure an aerodynamic continuity, the air inlet structure comprising at least one inner panel fixed to the central structure and forming with the latter a fixed structure of the nacelle, and at least a longitudinal outer panel attached in a removable manner to the fixed structure and integrating an air inlet lip to form a removable air inlet structure, wherein the removable air inlet structure is associated to a system for actuating according to claim 1.
